(19) United States
(12) Patent Application Publication
(10) Pub. No.: US 2024/0036008 A1
(43) Pub. Date: Feb. 1, 2024

(54) ULTRASOUND SCANNING SYSTEM WITH ADAPTIVE SIGNAL TRANSMISSION TIMING

(71) Applicant: DolphiTech AS, Gjøvik (NO)

(72) Inventor: Eskil Skoglund, Gjøvik (NO)

(21) Appl. No.: 18/041,356

(22) PCT Filed: Aug. 25, 2021
(86) PCT No.: PCT/IB2021/057792

§ 371 Date: Feb. 10, 2023

(30) Foreign Application Priority Data
Aug. 14, 2020 (GB) 2012729.6
Mar. 18, 2021 (GB) 2103798.1

(51) Int. Cl. G01N 29/06; G01N 29/04; G01N 29/44

(52) U.S. Cl. CPC G01N 29/069; G01N 29/043; G01N 29/0645; G01N 29/4454; G01N 29/4445; G01N 2291/0234; G01N 2291/044; G01N 2291/106; G01N 2291/0258; G01N 2291/0231; G01N 2291/2694

(57) ABSTRACT

A scanning system for imaging structural features below the surface of an object, the scanning system comprising: a transducer module configured to transmit ultrasound signals towards an object and to receive ultrasound signals reflected from the object whereby data pertaining to an internal structure of the object can be obtained; and an analysis module coupled to the transducer module and configured to analyse received ultrasound signals to identify a feature in the received ultrasound signals; in which the transducer module is configured to transmit further ultrasound signals at a time delay t after the ultrasound signals, where the time delay t is determined in dependence on the identified feature.

### CROSS-REFERENCE TO RELATED APPLICATIONS

This application is the national stage entry of International Patent Application No. PCT/IB2021/057792, filed on Aug. 25, 2021, and claims priority to Application No. GB2012729.6, filed in the United Kingdom on Aug. 14, 2020, and claims priority to Application No. GB2103798.1, filed in the United Kingdom on Mar. 18, 2021, the disclosures of which are hereby incorporated by reference thereto.

### FIELD OF THE INVENTION

This invention relates to an ultrasound scanning system for imaging structural features below the surface of an object. In particular, the present disclosure relates to a scanning system in which a time delay between transmission of ultrasound signals can be determined in dependence on a feature identified in received ultrasound signals.

### BACKGROUND

A scanning system typically includes a transducer module. The transducer module is for imaging an object, for instance for imaging structural features below an object's surface. The transducer module may be particularly useful for imaging sub-surface material defects such as delamination, debonding and flaking.

Ultrasound can be used to identify particular structural features in an object. For example, ultrasound may be used for non-destructive testing by detecting the size and position of flaws in a sample. There are a wide range of applications that can benefit from non-destructive testing, covering different materials, sample depths and types of structural feature, such as different layers in a laminate structure, impact damage, boreholes etc. Ultrasound is an oscillating sound pressure wave that can be used to detect objects and measure distances. A transmitted sound wave is reflected and refracted as it encounters materials with different acoustic impedance properties. If these reflections and refractions are detected and analysed, the resulting data can be used to describe the environment through which the sound wave travelled. It is desirable to enhance the quality of the resulting data so as to increase the accuracy of the ultrasound scan.

### SUMMARY

According to an aspect of the present invention, there is provided a scanning system for imaging structural features below the surface of an object, the scanning system comprising:
a transducer module configured to transmit ultrasound signals towards an object and to receive ultrasound signals reflected from the object whereby data pertaining to an internal structure of the object can be obtained; and an analysis module coupled to the transducer module and configured to analyse received ultrasound signals to identify a feature in the received ultrasound signals;
in which the transducer module is configured to transmit further ultrasound signals at a time delay t after the ultrasound signals, where the time delay t is determined in dependence on the identified feature.

The analysis module may be configured to identify an amplitude of a peak in the received ultrasound signals, and the identified feature may comprise a change in the amplitude of the peak. The peak in the received ultrasound signals may be a peak of a reflection received from within the object. The identified feature may comprise a rate of change of the amplitude of the peak. The identified feature may comprise a percentage change in the amplitude of the peak compared to an initially determined amplitude of the peak. The identified feature may comprise a change in the amplitude of the peak past a threshold amplitude. The threshold amplitude may be based on one or more of; a material of an object for scanning; a structure of an object for scanning; a depth of a feature of interest; a flaw to be investigated; a thickness of an object for scanning; a coupling medium to be used between the transducer module and an object for scanning; a characteristic of the transducer module; and a threshold selection value.

The identified feature may be indicative of a level of corrosion in the object. The identified feature may be indicative of whether the corrosion is on an external face of the object and/or at an interior of the object.

The identified feature may be indicative of an ultrasound path length between a transmitting surface of the transducer module and the object. The identified feature may be indicative of a thickness of a coupling pad disposed between the transmitting surface and the object. The identified feature may be indicative of a depth of coupling fluid between the transmitting surface and the object.

The identified feature may be indicative of a noise level in the received ultrasound signals.

The transducer module may comprise a plurality of transducer elements arranged in an array, and the time delay t may be the same for each transducer element.

The transducer module may comprise a plurality of transducer elements arranged in an array, and the time delay t may comprise a first time delay t₁ for a first subset of the transducer elements and a second time delay t₂ for a second subset of the transducer elements. The first time delay t₁ may be determined in dependence on ultrasound signals received at the first subset of the transducer elements and the second time delay t₂ may be determined in dependence on ultrasound signals received at the second subset of the transducer elements. For each transducer element; the analysis module may be configured to analyse ultrasound signals received at that transducer element to identify a respective feature in the received ultrasound signals, and a respective time delay tᵣₑₛₚ may be determined in dependence on the respective identified feature for that transducer element. The respective time delays tᵣₑₛₚ for each transducer element in the array may fit a function that varies smoothly with position in the array.

The scanning system may comprise an image generator configured to generate an image scan representative of structural features below a surface of an object in dependence on the received ultrasound signals; a display coupled to the image generator and configured to display the image scan; and a user input device configured to generate an indication signal whereby a user can indicate a portion of the displayed image scan; the analysis module may be configured to identify the feature in response to the generated indication signal.

According to another aspect of the present invention, there is provided a method of imaging structural features below the surface of an object, the method comprising:
transmitting ultrasound signals towards an object and to receive ultrasound signals reflected from the object whereby data pertaining to an internal structure of the object can be obtained; and
analysing received ultrasound signals to identify a feature in the received ultrasound signals; and
transmitting further ultrasound signals at a time delay t after the ultrasound signals, where the time delay t is determined in dependence on the identified feature.

Any one or more feature of any aspect above may be combined with any other aspect. These have not been written out in full here merely for the sake of brevity.

### BRIEF DESCRIPTION OF THE DRAWINGS

The present invention will now be described by way of example with reference to the accompanying drawings. In the drawings:

FIG. 1 shows a device for imaging an object;

FIG. 2 shows an example of a scanning system and an object;

FIG. 3 shows an example of the functional blocks of a scanning system;

FIG. 4 shows a schematic illustration of a transducer module;

FIG. 5 shows an example of a scanning system coupled to a pipe;

FIG. 6 shows a schematic B-scan obtained using the system illustrated in FIG. 5;

FIG. 7 shows a transducer module coupled to an object;

FIG. 8 shows a schematic B-scan obtained using the system illustrated in FIG. 7;

FIG. 9 shows a block diagram of a scanning system;

FIG. 10 schematically illustrates examples of received ultrasound reflections;

FIG. 11 is a flowchart of an illustrative method of gating ultrasound reflections;

FIG. 12 is a flowchart of another illustrative method of gating ultrasound reflections;

FIG. 13 is a flowchart of an illustrative method of identifying a feature in ultrasound signals; and

FIG. 14 is a flowchart of another illustrative method of gating ultrasound reflections.

FIG. 15 is a flowchart of an illustrative method of determining a time delay.

### DETAILED DESCRIPTION

A scanning system can transmit sound pulses towards an object to be imaged, and receive reflected sound pulses from the object, so as to image the object. Where sound pulses are transmitted too close to one another, they can interfere with one another. For example, echoes from a first sound pulse can remain in the object after the second sound pulse has been transmitted. This can cause artefacts in an image generated using the reflected sound pulses. The present techniques address this problem by automatically determining a time delay t by which to delay the second sound pulse after the first sound pulse (or more generally, a time delay between subsequent pulses in a scan). This time delay is determined based on a feature identified in the received ultrasound signals. Thus, the scanning system can be reactive to the results of the scan, and the time delay can be dynamically modified as desired, for example to optimise a balance between frame rate and signal to noise ratio. A scanning system in accordance with this approach will be described in more detail below.

A scanning system typically gathers information about structural features located different depths below the surface of an object. One way of obtaining this information is to transmit sound pulses at the object and detect any reflections. It is helpful to generate an image depicting the gathered information so that a human operator can recognise and evaluate the size, shape and depth of any structural flaws below the object's surface. This is a vital activity for many industrial applications where sub-surface structural flaws can be dangerous. An example is aircraft maintenance.

Usually the operator will be entirely reliant on the images produced by the apparatus because the structure the operator wants to look at is beneath the object's surface. It is therefore important that the information is imaged in such a way that the operator can evaluate the object's structure effectively.

Ultrasound transducers make use of a piezoelectric material, which is driven by electrical signals to cause the piezoelectric material to vibrate, generating the ultrasound signal. Conversely, when a sound signal is received, it causes the piezoelectric material to vibrate, generating electrical signals which can be detected.

The ultrasound signals received by the transducer can be analysed based on their amplitude and time-of-flight. The data can be used to generate B-scan images, typically showing a slice through the object being scanned, and/or C-scan images, typically showing a planar representation of the object. Where the object's surface is planar, for example a flat metal plate, the B-scan image (or simply ‘B-scan’) and the C-scan image (or simply ‘C-scan’) can readily be analysed. The penetration echo in the B-scan will be a flat, typically horizontal (e.g. where a planar transducer is perpendicular to the flat surface of the object), line in the B-scan. Depth information relating to features of interest can be extracted from the B-scan with relatively little additional processing and/or readily understood by a human operator when viewing the B-scan. Similarly, the C-scan will contain data based on distance from the transducer which can correspond directly to depth in the object. Again, information relating to features of interest can be extracted from the C-scan with relatively little additional processing and/or readily understood by a human operator when viewing the C-scan.

### Gating Ultrasound Signals

When an object's surface is not planar and/or where the distance between the transducer module and the object's surface is not constant across the width of the transducer. In such cases, the data represented in B-scans and C-scans can be more difficult to analyse. Additional processing may need to be performed on the data before accurate results can be obtained from an analysis of the data. Where the scan data is being analysed later than the performing of the scan itself, it may not be possible to re-scan the object, or to adjust the scanning parameters for scanning the object.

A scanning system can adaptively gate the ultrasound signals so as to better be able to analyse the data. This adaptive gating can be performed contemporaneously with the scanning of the object, enabling the gating to be performed dynamically as the object is being scanned.

Conceptually, dynamically gating received ultrasound signals, for example based on a distance between a transducer module and a surface of an object under analysis, can be considered to “latten” the resulting scan data, such that analysis can more easily be performed on the scan data. For instance, the position of features may more readily correspond to a depth below the surface of an object in such a “flattened” scan, compared to a scan that has not been “flattened” in this way.

Suitably, the dynamic gating can take account of curvature in at least one direction. The present techniques can therefore be useful in analysing objects with surface curvature in one direction, such as a cylindrical pipe, and in more than one direction, such as a curved car body panel.

A scanning system such as an ultrasound scanning system is useful in imaging an object. The scanning system comprises a transducer module, which suitably includes an ultrasound transducer, an analysis module coupled to the transducer module, and a gating module. The transducer module can transmit ultrasound signals towards an object and receive reflected ultrasound signals from the object. The analysis module can analyse received ultrasound signals to identify a feature in the received ultrasound signals. The gating module can gate received ultrasound signals in dependence on the identified feature.

This approach permits the gating of the ultrasound signals based on features in those signals, and/or based on features in earlier received signals. That is, the transducer module can transmit a first set of ultrasound signals and receive a corresponding first set of reflected ultrasound signals. The analysis module can determine the presence and/or characteristics of one or more features in that first set of reflected ultrasound signals. The gating module can then determine a gating to apply to ultrasound signals based on the analysis of the first set of reflected ultrasound signals.

The determined gating can be applied to the first set of reflected ultrasound signals. For example, the reflected signals can be stored in a storage medium such as a local and/or a remote data store. for example a memory such as a RAM. The reflected signals can be accessed by, and/or made available to, the analysis module to perform the analysis. The reflected signals can be accessed by, and/or made available to, the gating module so that the gating module can gate those reflected signals based on the analysis.

The determined gating, i.e. the gating based on the analysis of the first set of reflected ultrasound signals, can additionally or alternatively be applied to a second set of reflected ultrasound signals, which can be received in response to the transmission by the transducer module of a second set of ultrasound signals.

Such a scanning system can determine relevant features in ultrasound reflections so as to be able to adaptively and/or dynamically gate ultrasound reflections. This can enable gating of the reflections according to characteristics of the reflections associated with features such as the penetration echo, the back wall echo, and reflections caused by internal structural features of the object under analysis. The system can thereby generate more accurate data from the ultrasound analysis that can, for example, automatically take account of object surface curvature, transducer-object distance, object thickness, object material, and/or depth of internal features, and so on.

This can provide a more flexible scanning system, with enhanced accuracy and/or usability.

Additionally or alternatively, a scanning system suitably includes a plurality of transducer elements which form an array of transducer elements. Each element is able to transmit ultrasound signals and to receive reflections of those transmitted ultrasound signals. The scanning system includes a signal processor which obtains the received ultrasound signals from the plurality of transducers and processes the received signals so as to image the interior of an object under analysis. The processing suitably comprises gating the signals based on a position in the array of the transducer element at which the signals are received.

Such a scanning system enables a gating function to be applied which can differ between different transducer elements in an array of transducer elements. This approach can be useful where characteristics of the scanning system and/or object under analysis differ across, respectively, the scanning system and/or the object. For example, the object's surface may not be planar. The use of a gating function which can vary with position across an array enables selective gating of signals from different locations along the object. Such an approach can lead to enhancements in the analysis of the ultrasound signals and in the flexibility of the scanning system in scanning different objects, whether with known or unknown surface profiles.

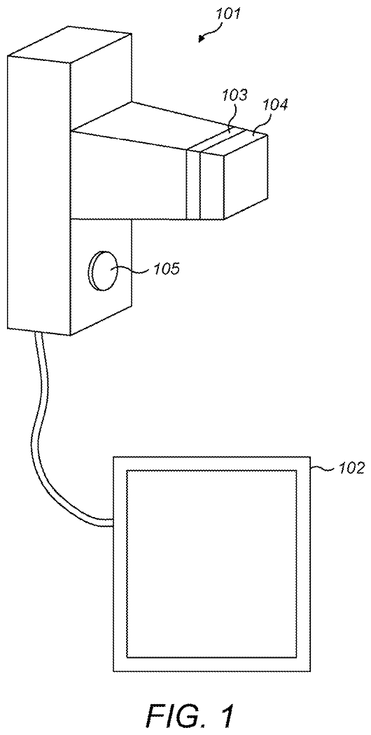

Further detail of a scanning system in accordance with techniques relating to adaptive gating is described below with reference to the figures. An example of a handheld device, such as a scanning system described herein, for imaging below the surface of an object is shown in FIG. 1. The device 101 could have an integrated display, but in this example it outputs images to a tablet computer 102. The connection with the tablet could be wired, as shown, or wireless. The device has a matrix array 103 for transmitting and receiving ultrasound signals. Suitably the array is implemented by an ultrasound transducer comprising a plurality of electrodes arranged in an intersecting pattern to form an array of transducer elements. The transducer elements may be switched between transmitting and receiving. The handheld apparatus as illustrated comprises a coupling layer such as a dry coupling layer 104 for coupling ultrasound signals into the object. The coupling layer also delays the ultrasound signals to allow time for the transducers to switch from transmitting to receiving. The coupling layer need not be provided in all examples. The scanning system can comprise a coupling shoe attached to the front of the transducer.

The matrix array 103 is two dimensional so there is no need to move it across the object to obtain an image. A typical matrix array might be approximately 30 mm by 30 mm but the size and shape of the matrix array can be varied to suit the application. The device may be straightforwardly held against the object by an operator. Commonly the operator will already have a good idea of where the object might have sub-surface flaws or material defects; for example, a component may have suffered an impact or may comprise one or more drill or rivet holes that could cause stress concentrations. The device suitably processes the reflected pulses in real time so the operator can simply place the device on any area of interest.

The handheld device also comprises a dial 105 or other user input device that the operator can use to change the pulse shape and corresponding filter. In other examples the dial need not be provided. Selection of the pulse shape and/or filter can be made in software. The most appropriate pulse shape may depend on the type of structural feature being imaged and where it is located in the object. The operator can view the object at different depths by manually adjusting the time-gating via the display. Having the apparatus output to a handheld display, such as the tablet 102, or to an integrated display, is advantageous because the operator can readily move the transducer over the object, or change the settings of the apparatus, depending on what is seen on the display and get instantaneous results. In other arrangements, the operator might have to walk between a non-handheld display (such as a PC) and the object to keep rescanning it every time a new setting or location on the object is to be tested.

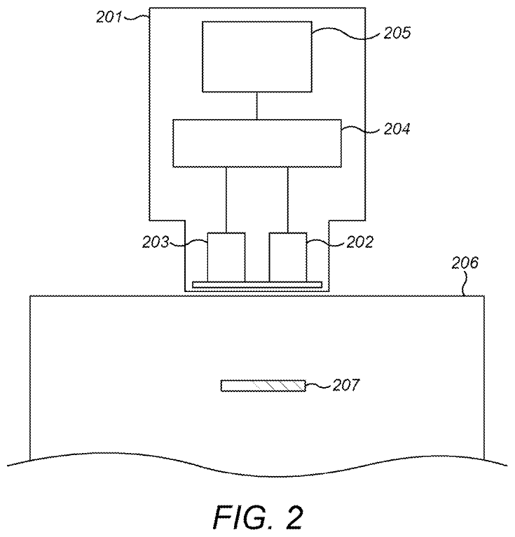

A scanning system for imaging structural features below the surface of an object is shown in FIG. 2. The apparatus, shown generally at 201, comprises a transmitter 202, a receiver 203, a signal processor 204 and an image generator 205. In some examples the transmitter and receiver may be implemented by an ultrasound transducer. The transmitter and receiver are shown next to each other in FIG. 2 for ease of illustration only. The transmitter 202 is suitably configured to transmit a sound pulse having a particular shape at the object to be imaged 206. The receiver 203 is suitably configured to receive reflections of transmitted sound pulses from the object. A sub-surface feature of the object is illustrated at 207.

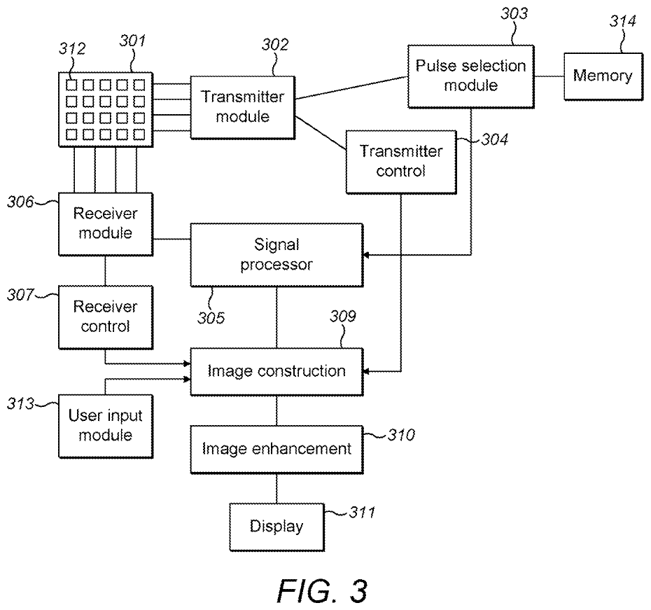

An example of the functional blocks comprised in one embodiment of the apparatus are shown in FIG. 3. In this example the transmitter and receiver are implemented by an ultrasound transducer 301, which comprises a matrix array of transducer elements 312. The transducer elements transmit and/or receive ultrasound waves. The matrix array may comprise a number of parallel, elongated electrodes arranged in an intersecting pattern; the intersections form the transducer elements. The transmitter electrodes are connected to the transmitter module 302, which supplies a pulse pattern with a particular shape to a particular electrode. The transmitter control 304 selects the transmitter electrodes to be activated. The number of transmitter electrodes that are activated at a given time instant may be varied. The transmitter electrodes may be activated in turn, either individually or in groups. Suitably the transmitter control causes the transmitter electrodes to transmit a series of sound pulses into the object, enabling the generated image to be continuously updated. The transmitter electrodes may also be controlled to transmit the pulses using a particular frequency. The frequency may be between 100 kHz and 30 MHz, preferably it is between 0.5 MHz and 15 MHz and most preferably it is between 0.5 MHz and 10 MHz.

The receiver electrodes sense sound waves that are emitted from the object. These sound waves are reflections of the sound pulses that were transmitted into the object. The receiver module receives and amplifies these signals. The signals are sampled by an analogue-to-digital converter. The receiver control suitably controls the receiver electrodes to receive after the transmitter electrodes have transmitted. The apparatus may alternately transmit and receive. In one embodiment the electrodes may be capable of both transmitting and receiving, in which case the receiver and transmitter controls will switch the electrodes between their transmit and receive states. There is preferably some delay between the sound pulses being transmitted and their reflections being received at the apparatus. The apparatus may include a coupling layer (such as the dry coupling and/or as provided by the coupling shoe) to provide the delay needed for the electrodes to be switched from transmitting to receiving. Any delay may be compensated for when the relative depths are calculated. The coupling layer preferably provides low damping of the transmitted sound waves.

Each transducer element may correspond to a pixel in the image. In other words, each pixel may represent the signal received at one of the transducer elements. This need not be a one-to-one correspondence. A single transducer element may correspond to more than one pixel and vice-versa. Each image may represent the signals received from one pulse. It should be understood that “one” pulse will usually be transmitted by many different transducer elements. These versions of the “one” pulse might also be transmitted at different times, e.g. the matrix array could be configured to activate a “wave” of transducer elements by activating each line of the array in turn. This collection of transmitted pulses can still be considered to represent “one” pulse, however, as it is the reflections of that pulse that are used to generate a single image of the sample. The same is true of every pulse in a series of pulses used to generate a video stream of images of the sample.

The pulse selection module 303 selects the particular pulse shape to be transmitted. It may comprise a pulse generator, which supplies the transmitter module with an electronic pulse pattern that will be converted into ultrasonic pulses by the transducer. The pulse selection module may have access to a plurality of predefined pulse shapes stored in a memory 314. The pulse selection module may select the pulse shape to be transmitted automatically or based on user input. The shape of the pulse may be selected in dependence on the type of structural feature being imaged, its depth, material type etc. In general the pulse shape should be selected to optimise the information that can be gathered by the signal processor 305 and/or improved by the image enhancement module 310 in order to provide the operator with a quality image of the object.

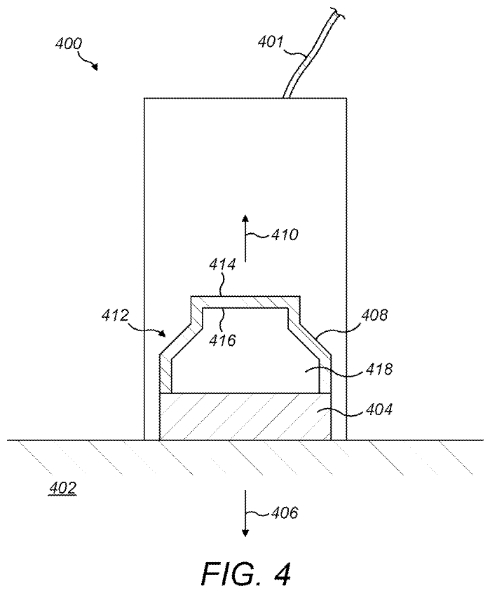

FIG. 4 schematically illustrates a transducer module. The transducer module (TRM) is generally indicated at 400. An electrical connection such as a cable 401 couples the TRM to a remote system. The remote system can provide driving signals and can receive detected signals. The transducer module is shown as being placed against an object under test 402. The TRM comprises a transducer 404. The transducer 404 comprises a transmitter. The transducer comprises a receiver. The transmitter and receiver may be separately provided. Details of the transducer structure and its electrical connections are omitted from this figure for clarity. The transducer is configured to transmit ultrasound signals towards the object to be imaged. The transducer is suitably configured to transmit ultrasound signals in a direction indicated at 406.

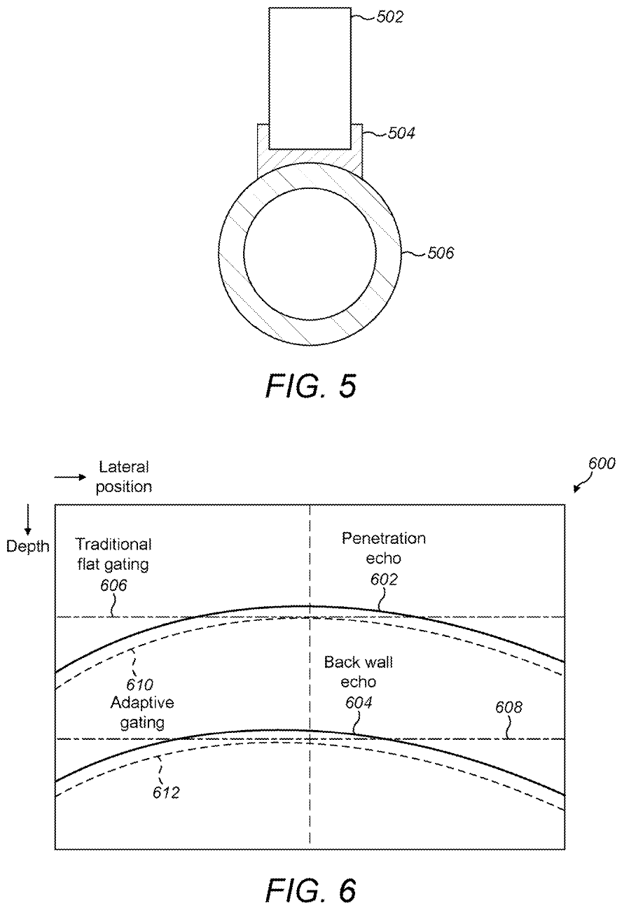

FIG. 5 shows a scanning system comprising a transducer module 502 coupled via a coupling shoe 504 to a pipe 506 for scanning the exterior surface of the pipe. FIG. 6 shows a schematic B-scan 600 obtained using the system illustrated in FIG. 5. In the illustrated B-scan, the curved solid lines represent the front and back walls of the pipe. The upper solid line 602 represents the penetration echo, i.e. the reflection received from the interface between the coupling shoe and the pipe surface. The lower solid line 604 represents the back wall echo, i.e. the reflection received from the interface between the pipe inner surface and air within the hollow interior of the pipe.

A traditional gating applied in a scanning system is illustrated in FIG. 6 at 606 and 608. The flat gating is based on the separation between the transducer module 502 and the pipe 506 at a central position. The flat gating is applied just after the penetration echo (so as not to include the penetration echo in the gated data) and just after the back wall echo (so as to include data relating to the back wall in the gated data). Scanning systems can comprise a single transducer element that is of a very limited lateral extent. Such a transducer will need to be moved across the surface of the pipe to image across the pipe. In this case, the flat gating is appropriate since the curvature seen at each point is minimal. This is because the transducer, as it is moved, is continually angled so as to be normal to the surface of the pipe at the location of the pipe which is being scanned.

The present inventors have realised that whilst this traditional flat gating is useful in such single transducer element scanning systems, the flat gating is less accurate where either a single transducer element has a larger physical extent or where multiple transducer elements are used together in an array where each element in the array can be arranged differently relative to the object's surface (i.e. where one or both of the transducer array and the object's surface are non-planar in at least one direction).

In this case, as will be understood from FIG. 6, the flat gating is inaccurate. Looking at the left hand side of FIG. 6 it can be seen that the flat gating fails to exclude the penetration echo, and also cuts out the back wall echo and other potentially desirable data relating to an interior of the pipe. Thus the flat gating will be unlikely to correctly gate the ultrasound signals except in a narrow region near the centre of the image. The width of the image where the flat gating remains useful is highly dependent on the surface profiles of both the transducer module and the object.

In the present techniques, the gating is adapted based on identified features in the received ultrasound signals. For example, again referring to FIG. 6, the penetration echo can be identified and a gating applied a pre-set depth below the penetration echo. This is illustrated by a dashed line 610 that follows the penetration echo curve in the B-scan 600. The back wall echo can also be identified and a gating applied a pre-set depth below the back wall echo. This is illustrated by a further dashed line 612 that follows the back wall echo curve in the B-scan 600. Suitably the pre-set depths of the adaptive gating below the respective ultrasound features are the same. In some cases the adaptive gating can be applied at a first depth below (or time after) the penetration echo and at a second depth below (or time after) the back wall echo. The first and second depths (or times) need not be the same. The depths can be selected according to a user selection, or automatically by the scanning system. The scanning system can be configured to determine the depth based on, for example, one or more of a feature amplitude, a feature width, a feature shape, a plurality of features in the data, a material or material type being imaged, a defect or defect type being imaged, and so on. The scanning system can be configured to determine the depth based on, for example, a characteristic of the scanning system such as one or more of transducer resolution, transducer frequency, transducer frequency range, transducer size, and so on.

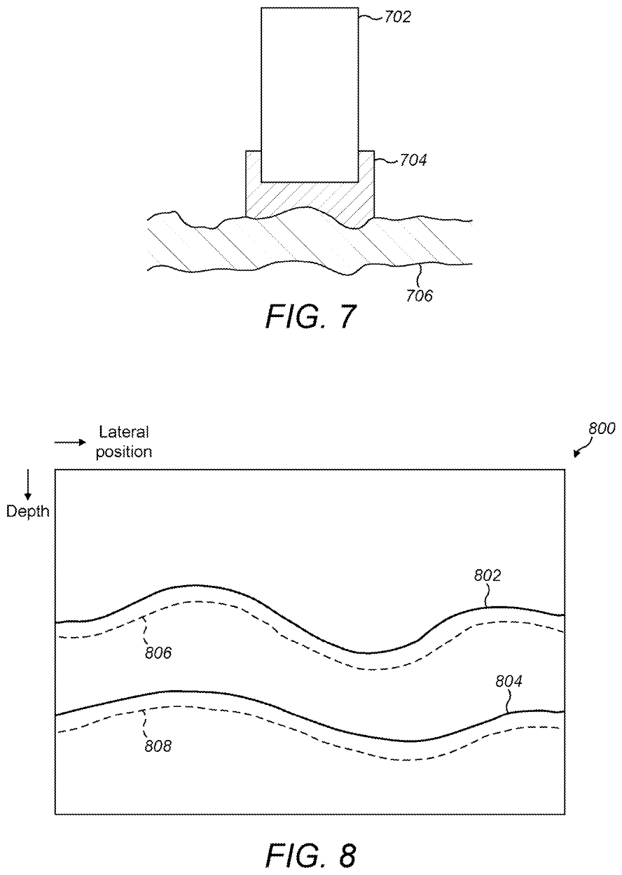

Identifying one or more features in the received ultrasound signals and basing the adaptive gating on those one or more features means that the particular characteristics of the object under analysis need not be known prior to the analysis. An example of this is illustrated in FIGS. 7 and 8. FIG. 7 shows a transducer module 702 coupled via a coupling 704 to an object 706 with an irregular, non-planar surface. The coupling is optionally a dry coupling or similar. In general the coupling can comprise or form a delay line. Preferably the coupling comprises a soft and/or flexible coupling material, for example an elastomeric material, such that the coupling permits a coupling between the transducer module and an irregular or non-planar surface.

FIG. 8 shows a schematic B-scan 800 obtained using the system illustrated in FIG. 7. In the illustrated B-scan, the curved solid lines represent the front and back walls of the object. The upper solid line 802 represents the penetration echo, i.e. the reflection received from the interface between the coupling and the object's upper surface (in the orientation of FIG. 7). The lower solid line 804 represents the back wall echo, i.e. the reflection received from the interface between the object's lower surface (in the orientation of FIG. 7) and air behind the object.

The scanning system is configured to identify, in the received ultrasound signals, the penetration echo and the back wall echo. In this example, the adaptive gating is applied at a pre-set depth below (or time after) both the penetration echo 802 and the back wall echo 804. The resulting adaptive gating is illustrated at 806 and 808, respectively. As can be seen, the adaptive gating follows the curvature of the object. The gating applied to the reflections received from the front of the object may be the same as or different to the gating applied to the reflections received from the back of the object (and/or from any interior feature of the object). The gating applied to the penetration echo may be the same as or different to the gating applied to the back wall echo. The thickness of the object is not necessarily treated as constant, though it might be. The thickness may be treated as varying across the object width. The thickness may vary according to a known or determined function, such as a linear or non-linear function. For example, the thickness may gradually increase in one direction, for example where the object is a wedge. The thickness may increase and decrease alternately, for example where one of the front and back surfaces of the object is corrugated. Other thickness variations can also be accounted for using the present adaptive gating techniques.

Since one or more features in the received ultrasound signals can be identified by the scanning system, the system can base the adaptive gating on the identified one or more features. This approach can therefore enable an appropriate gating to be applied to ultrasound signals reflected from an object. The object's front surface profile need not be known in advance. The object's rear surface profile need not be known in advance. The present techniques are also effective where the object is of unknown thickness. The present techniques are useful where the thickness of the object is constant or where the thickness can vary across the object.

Suitably the scanning system 900 is for imaging structural features below the surface of an object. The scanning system can image internal features of the object, or an interior of the object. The scanning system comprises a transducer module 902, an analysis module 904 and a gating module 906.

The transducer module 902 is for transmitting ultrasound signals towards an object and for receiving ultrasound signals reflected from the object. This permits data pertaining to an internal structure of the object to be obtained. The transducer module is suitably configured to transmit and receive the ultrasound signals and reflections. The transducer module 902 suitably comprises one or more transducers or transducer elements 908.

The analysis module 904 is coupled to the transducer module 902. The analysis module can analyse received ultrasound signals. The analysis module is suitably configured to analyse the received ultrasound signals. The analysis module can thereby identify one or more features in the received ultrasound signals, for example a penetration echo, a back wall echo, and one or more features such as defects within the interior of the object (i.e. between the penetration echo and the back wall echo).

The gating module 906 can gate the received ultrasound signals based on the one or more features identified by the analysis module. The gating module is configured to gate the received ultrasound signals in dependence on the identified feature(s), for example by selectively retaining a portion of the received signals based on the identified feature(s) and/or the depth/time of the identified feature(s) in the received data. This will be explained in more detail elsewhere herein.

The analysis module 904 is configured to identify a penetration echo in the received ultrasound signals and the gating module 906 is configured to gate the received ultrasound signals to selectively retain signals received after the penetration echo. The gating module 906 can be configured to gate the received ultrasound signals to retain a plurality of subsets of signals received at respective times after the penetration echo. For example, in one implementation, the gating module can retain all data received after the penetration echo, or all data received after the penetration echo until just after the back wall echo. In another implementation, the gating module can retain selective portions of data received after the penetration echo. The portions may be selected based on features identified in the received ultrasound signals. For example, a portion surrounding or centred on a feature of interest can be retained. The width of the retained portion can be pre-set or can be selected based on a characteristic of the object under analysis and/or the scanning system and/or a characteristic of the received signals (such as amplitude of a peak, width of a peak, signal-to-noise ratio, peak separation, type of feature and so on). This approach enables data to be retained that relates to features of interest, whilst permitting data that does not relate to features of interest to be discarded. Such an approach can therefore help reduce data storage, transfer and processing costs whilst retaining relevant data for analysis.

The respective times at which the plurality of subsets are received can be discontinuous. That is, the retained data may relate to one or more features that are spaced from one another within the interior of the object under analysis. For example, the adaptive gating may cause data received from the object just after the penetration echo to be retained, together with data received from the object just before the back wall echo. The adaptive gating may also, or alternatively, cause data to be retained that relates to different features within the object, such as data representing one or more internal material boundaries and/or internal defects such as delamination.

The gating module 906 is suitably configured to gate the received ultrasound signals in accordance with a gating function selected from a group of gating functions. The group of gating functions may be stored at a data store 910 such as a memory (e.g. a RAM) that is at or accessible to the gating module 906. Where the data store is provided separately from the gating module, the gating module 906 is coupled to the data store 910. The gating module 906 is configured to select the gating function based on one or more of:
a material of an object for scanning;
a structure of an object for scanning such as the object's surface profile and/or thickness;
a depth of a feature of interest;
a flaw or type of flaw to be investigated, such as a crack, stress fracture, delamination, and so on;
a coupling medium to be used between the transducer module and an object for scanning; and
a gating selection signal received by the gating module (which gating selection signal might comprise an indication of the above options).

The analysis module 904 is suitably configured to identify a back wall echo in the received ultrasound signals and the gating module 906 is suitably configured to gate the received ultrasound signals to selectively retain signals based on the timing of the back wall echo. For instance, the adaptive gating can be such as to retain signals received in a time range before the back wall echo, or signals received in a time range that extends both before and after the timing of receipt of the back wall echo. The time range may be pre-set or can be selected based on a characteristic of the object under analysis and/or the scanning system and/or a characteristic of the received signals (such as amplitude of a peak, width of a peak, signal-to-noise ratio, peak separation, type of feature and so on).

The analysis module 904 is suitably configured to identify a material discontinuity feature in the received ultrasound signals, and the gating module 906 is suitably configured to gate the received ultrasound signals in dependence on the identified material discontinuity feature. The material discontinuity feature can be identified in the received ultrasound signals between the penetration echo and the back wall echo. For example, the adaptive gating can be applied so as to retain signals received in a time range that extends either before the timing of the identified feature, after the timing of the identified feature, or both before and after the timing of the identified feature. The time range may be centred on the identified feature, or on a peak of the identified feature, but it need not be. The extent of the time range either before or after the identified feature can be pre-set or can be selected based on a characteristic of the object under analysis and/or the scanning system and/or a characteristic of the received signals (such as amplitude of a peak, width of a peak, signal-to-noise ratio, peak separation, type of feature and so on).

Suitably, the respective times of the plurality of subsets of signals are determined from one or more of the timings of the penetration echo, the back wall echo and the material discontinuity feature.

Reference is now made to FIG. 10, which schematically illustrates received ultrasound reflections. A penetration echo is illustrated at 1002 and has a peak amplitude of P1. A back wall echo is illustrated at 1004 and has a peak amplitude of P2. Internal feature echoes are illustrated at 1006 and 1008 and have peak amplitudes of P3 and P4, respectively. The analysis module 904 is configured to identify the penetration echo 1002 by identifying a first peak in the received ultrasound signals with an amplitude that exceeds a penetration echo threshold amplitude, P_th1. Identifying a peak with an amplitude greater than P_th1 can ensure that peaks due to noise are not incorrectly identified as the penetration echo. The penetration echo is expected to have a high amplitude, and so the value for the penetration echo threshold amplitude can be selected to ensure that the penetration echo is correctly identified. The value of the threshold amplitude can be selected in dependence on a characteristic of the object under analysis and/or the scanning system. The value of the threshold amplitude can be user-selectable. For example, the value of P_th1 can be 6 dB below a maximum amplitude P_th2 (see below). The value of P_th1 may be calculated as a given proportion of a maximum output, such as the output amplitude or intensity, of the transducer module. For example, the value of P_th1 may be 18 dB below the maximum output of the transducer module.

The analysis module 904 is configured to identify the penetration echo 1002 by identifying that the first peak has an amplitude less than a predetermined maximum amplitude, P_th2. Whilst the penetration echo is expected to have a high amplitude, there are cases where too high an amplitude of a peak can indicate that the following data is not appropriate for analysis. For example, where the transducer module is fired into air (which may be performed as part of a set-up procedure, or inadvertently by an operator of the scanning system) the peak amplitude is likely to be higher than would be expected for a typical penetration echo peak amplitude. Thus, the higher amplitude can indicate that the ultrasound signals have not penetrated an object. Where the transducer module is directed towards an object under analysis, but the coupling between the transducer module and the object is poor, there may be a low proportion of ultrasound that couples into the object, and a high proportion that reflects back towards the transducer module. Here again the peak amplitude is likely to be higher than would be expected for a typical penetration echo peak amplitude. This higher amplitude in this case can indicate that insufficient energy has penetrated the object, rendering the resultant interior reflections of low quality and/or low amplitude. Where there is insufficient energy penetrating into the object, the resulting signal-to-noise ratio of the reflections may be too low to obtain accurate analysis results. Here, the term ‘low’ is relative. The proportion of energy that it is desired to couple into an object can depend on the nature or characteristics of the object and/or the scanning system. For example, where a region close to the surface is being analysed, it may be acceptable for a lower proportion of the transmitted ultrasound energy to be coupled into the object. Where a region deeper within the object is to be analysed, it will be desirable to couple a relatively higher proportion of the transmitted ultrasound energy into the object. The frequency of ultrasound will affect the penetration depth. Thus, whether or not a proportion of the transmitted energy that is coupled into the object is seen as sufficient can also depend on characteristics of the transducer such as frequency of transmission, frequency response of reception, and so on.

Thus, whether or not the proportion of energy coupled into an object is considered ‘low’ can depend on at least the factors mentioned herein. A threshold proportion of energy to couple into the object can be determined based on the parameters of the analysis to be performed and/or predetermined or user-selected. This threshold proportion of energy can be used to inform the amplitude value to select as the maximum amplitude, P_th2. The value of P_th2 may be calculated as a given proportion of a maximum output, such as the output amplitude or intensity, of the transducer module. For example, the value of P_th2 can be 12 dB below the maximum output of the transducer module.

Hence, identification of the first peak, with an amplitude greater than P_th1 but less than P_th2 can assist in ensuring that the subsequent reflections received are suitable for analysis.

The analysis module 904 is configured to identify a minimum amplitude after the identified penetration echo, and the gating module 906 is configured to gate the received ultrasound signals to selectively retain signals received after the identified minimum amplitude. The identified minimum amplitude may be a minimum immediately following the identified penetration echo peak, P1. The analysis module 904 is configured to identify the minimum amplitude by determining a next minimum following the peak, P1, of the penetration echo 1002, e.g. where the amplitude drops below a threshold amplitude value. The threshold amplitude value is a proportion of the maximum amplitude of the penetration echo. The proportion of the maximum amplitude of the penetration echo selected as the threshold amplitude value can be selected as desired, for example based on a characteristic of the object and/or scanning system, and/or user-selected.

The analysis module 904 is configured to identify the back wall echo 1004 by identifying a final peak in the received ultrasound signals with an amplitude, P2, that exceeds a back wall echo threshold amplitude. P_th3. Identifying a peak with an amplitude greater than P_th3 can ensure that peaks due to noise are not incorrectly identified as the back wall echo. The value of the threshold amplitude can be selected in dependence on a characteristic of the object under analysis (for example an expected thickness or range of thicknesses) and/or the scanning system. The value of the threshold amplitude can be user-selectable. For example, the value of P_th3 can be 3 or 4 dB below P_th1.

The analysis module 904 is configured to identify a further minimum amplitude after the peak of the identified back wall echo 1004 and the gating module 906 is configured to gate the received ultrasound signals to selectively retain signals received before the identified further minimum amplitude. This approach means that the back wall echo itself will be retained for subsequent analysis. In other examples, the back wall echo need not be retained. The further minimum amplitude may be a minimum immediately following the identified back wall echo peak, P2. The analysis module 904 is configured to identify the further minimum amplitude by determining a further next minimum following the back wall echo peak, e.g. where the amplitude drops below a further threshold amplitude value. The further threshold amplitude value is a proportion of the maximum amplitude of the back wall echo. The proportion of the maximum amplitude of the back wall echo selected as the further threshold amplitude value can be selected as desired, for example based on a characteristic of the object and/or scanning system, and/or user-selected.

The analysis module 904 is configured to identify one or more material discontinuity features by identifying one or more peaks P3, P4, of features 1006, 1008 in the received ultrasound signals between the penetration echo 1002 and the back wall echo 1004. The analysis module 904 is configured to identify the one or more material discontinuity features by identifying peaks in the received ultrasound signals having an amplitude within a given amplitude range. The given amplitude range may depend on the amplitudes of one or both of the penetration echo 1002 and the back wall echo 1004, and/or on material(s) of the object, characteristics of the scanning system, and so on. Suitably, the given amplitude range is a range of amplitudes greater than an internal feature amplitude threshold, P_th4. Identifying internal features using peaks with amplitudes greater than P_th4 can help reduce the number of ‘false’ peaks identified that might be due to noise. Increasing the threshold can reduce the likelihood of identifying a noise peak as a peak due to an internal feature.

The scanning system 900 optionally comprises an image generator 912, a display 914 coupled to the image generator 912, and a user input device 916. The image generator 912 is configured to generate an image scan representative of structural features below a surface of an object in dependence on the received ultrasound signals. The display 914 is configured to display the image scan. The user input device 916 is configured to generate an indication signal whereby a user can indicate a portion of the displayed image scan. The analysis module 904 is configured to identify the feature in response to the generated indication signal.

The scanning system 900 need not comprise one or more of the image generator 912, the display 914, and the user input device 916. The scanning system 900 may alternatively or additionally comprise a communications port 918 for outputting a signal to cause a display remote from the scanning system 900 to display the generated image scan. The communications port 918 may output data representative of the received ultrasound signals to enable a remote image generator to generate the image scan. The remotely-generated image scan can be displayed on a remote display and/or passed back, for example via the communications port 918 for display on the display 914. This flexibility in configuration enables the scanning system 900 to couple to external systems where suitable, for example to use external processing capabilities, as appropriate.

The transducer module 902 can comprise a plurality of transducer elements 908 arranged in an array. For each transducer element the analysis module 904 is suitably configured to analyse ultrasound signals received at that transducer element to identify a respective feature in the received ultrasound signals. The gating module 906 is suitably configured to gate ultrasound signals received at that transducer element in dependence on the respective identified feature. The array may be a two-dimensional array of transducer elements. The gating function may have different profiles in different directions along the array.

The gating module 906 may be configured to gate received ultrasound signals in dependence on a velocity of the transducer module. The velocity is suitably a velocity of the transducer module relative to the object under analysis. Where the velocity is higher, a wider gating can be employed, e.g. the wider gating may include more pixels and/or a greater time-of-flight or range of times-of-flight. This approach enables the adaptive gating techniques to be used even where transducer module-object speeds are higher, whilst ensuring that features of interest are retained in the gated signals.

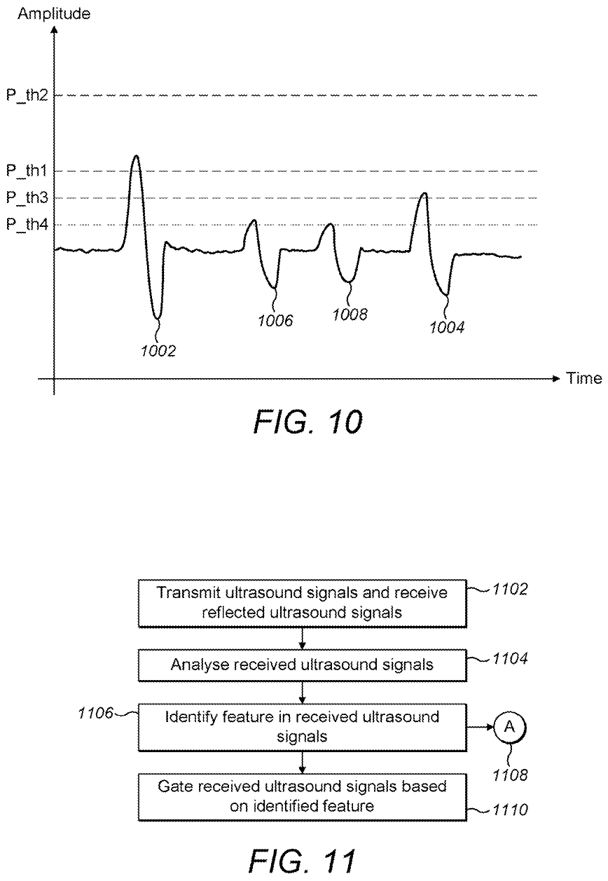

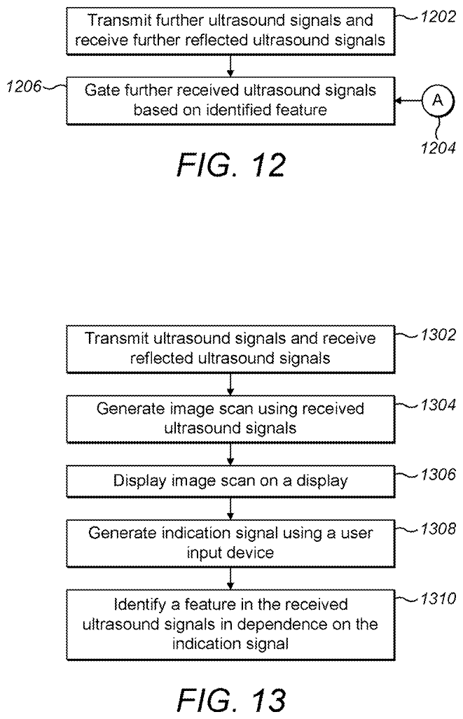

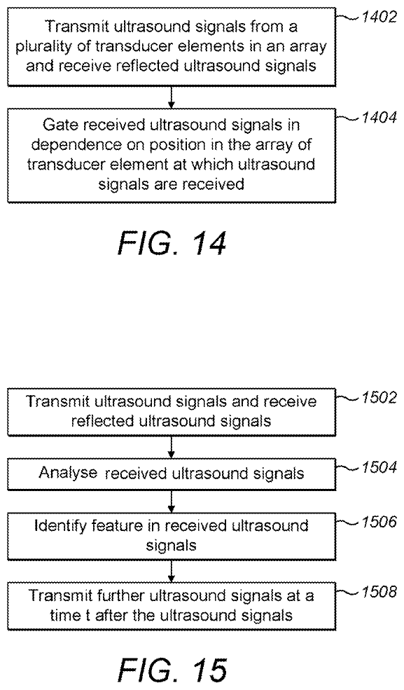

A method will now be described with reference to FIG. 11. Ultrasound signals are transmitted by a transducer module, for example by one or more transducer elements forming at least part of the transducer module. Reflections of the transmitted ultrasound signals are received 1102. The received ultrasound signals are analysed 1104. The analysis permits one or more features in the received ultrasound signals to be identified 1106. The one or more features can be identified by feature matching algorithms or similar. For example, a match filter can be used to identify matches with an expected shape of a reflected signal. The identified features, or data representing the identified features can be output at A 1108. The output can comprise sending the data to a further module, and/or storing the data for later access, for example by storing the data in a local and/or remote data store such as a memory, for example a RAM. Storing the data locally can enable faster save and load times. Storing the data remotely, such as in the cloud, can enable a greater amount of data to be stored without increasing the cost, complexity, and/or size of the scanning system. At 1110, received ultrasound signals are gated according to the one or more identified features. For example, the data representative of the one or more identified features can be used to gate the received ultrasound signals.

Thus, a set of received ultrasound signals can be used to determine the one or more identified features, and then a gating can be determined based on those one or more identified features. That gating can be used to gate the set of received ultrasound signals.

Additionally, or alternatively, further ultrasound signals can be transmitted and a further set of reflected ultrasound signals can be received by the transducer module 1202. Using the data representative of the one or more identified features 1204, identified using the set of received ultrasound signals, the further set of reflected ultrasound signals are gated, based on the one or more identified features 1206.

Thus, once features have been identified in a set of ultrasound reflections, for example one or more of a penetration echo, a back wall echo, and an echo derived from an internal feature of the object under analysis, those features can be used to determine a gating function (or set of gating functions). That gating function (or set of gating functions) can then be used to gate the set of ultrasound reflections and/or a further set of ultrasound reflections which may be received subsequent to the set of ultrasound reflections.

Referring now to FIG. 13, ultrasound signals are transmitted and reflections of those transmitted ultrasound signals are received 1302. An image scan is generated using the received ultrasound signals 1304. For example, the image scan can be generated by a local and/or a remote image generator. At 1306, the generated image scan is displayed on a display. The display can be a local and/or a remote display. An indication signal is generated using a user input device 1308. The user input device can form part of the scanning system but it need not. The user may view the image scan on the local and/or remote display, for example on a hand-held display forming part of the scanning system and/or on a monitor communicatively coupled to the scanning system. The scanning system identifies a feature in the received ultrasound signals based on the indication signal 1310.

The ultrasound signals can be transmitted from a single-element transducer or from a multiple-element transducer. In one example, ultrasounds signals are transmitted from a plurality of transducer elements in an array and reflections of those transmitted ultrasound signals are received by one or more of the plurality of transducer elements in the array 1402. The received ultrasound signals are gated in dependence on a position in the array of the transducer element at which the ultrasound signals are received 1404.

A scanning system for imaging structural features below a surface of an object (such as internal features of the object), which can optionally comprise any one or more of the above features in addition to the features below, can comprise a plurality of transducer elements forming an array. Each transducer element in the array is configured to transmit ultrasound signals towards an object and to receive ultrasound signals reflected from the object, enabling data pertaining to an internal structure of the object to be obtained. The scanning system further comprises a signal processor configured to obtain the received ultrasound signals from the plurality of transducers and to process the received ultrasound signals for imaging an interior of the object. The processing suitably comprises gating the received ultrasound signals based on a position in the array of the transducer element at which the received ultrasound signals are received.

Where the transducer array is planar, the position of a transducer in the array defines a position, which may be termed a lateral position, with respect to a scanning surface of the array. The position can also be relative to an object to be scanned by the scanning system. For example, where a planar array is parallel to a flat (or generally flat) surface of an object to be scanned, the position in the array will correspond to a position with respect to the object (where the scanning system is, for example, held in fixed relative location to the object).

Suitably, transducers in the array are configured to transmit ultrasound signals simultaneously. That is, there is suitably no delay, or no significant delay, in the transmission timing of the ultrasound signals transmitted by each transducer in the array.

The gating may be a linear or non-linear function of position of the transducer in the transducer array.

The signal processor is suitably configured to gate the received ultrasound signals in accordance with a gating function defining respective gating values for each transducer in the array. The gating values can be functions of position in the array. The gating function can define the same gating value for at least two transducers in the array. Suitably, the gating values describe a smooth function of position along the array. The gating function may comprise or describe a turning point and/or a point of inflection. The smooth function suitably describes an arc of a curved shape, such as a circle or an oval. The gating function may therefore correspond to or match the curvature of a pipe. For example, a gating function describing an arc of a circle can be used where ultrasound reflections are received from a pipe or similar object with a circular cross section. It will be understood that other cross-sectional shapes can be accommodated by other suitable curvatures of gating functions.

The signal processor is suitably configured to offset the gating in respect of neighbouring transducers in the transducer array. The offset may vary with distance across the transducer array, for example the offset can vary as a function of distance across the transducer array. The offset can vary linearly or non-linearly. That is, the gating timing can change smoothly with distance. The gating timing can comprise values which follow a curved function. The curved function may describe the arc of a circle. Suitably the transducer elements are regularly spaced in the array, but they need not be. The gating function applied to each transducer element may be based on the relative separation between the transducer elements in the array.

For a one dimensional transducer array (where, e.g., the transducer elements are arranged along an x-direction), the gating function may vary in the x-direction or in the x- and z-directions (where the z-direction is into the object, e.g. an ultrasound transmission direction). For a two dimensional transducer array (where, e.g., the transducer elements are arranged in the x-y plane), the gating function may vary in one direction or in more than one direction. The gating function may vary in an x-direction, in an x- and a y-direction, or in x-, y- and z-directions. Varying the gating function values in an x-direction can permit appropriate adaptive gating for a cylindrical pipe. Varying gating function values in both x- and y-directions can permit appropriate adaptive gating for two dimensional curved surfaces such as a curved car body panel. Varying gating function values in x-, y- and z-directions can further permit appropriate adaptive gating for objects where there are depth variations in the feature(s) of interest.

The signal processor is configured to select the gating function from a group of gating functions in response to a gating selection signal. The group of gating functions comprises a plurality of gating functions each defining gating values describing respective functions of position in the array. The respective functions can describe curves of differing curvature from one another. For example, the respective functions can describe arcs of circles of differing diameters. This can enable the gating functions to be matched with pipes of differing diameters. Suitably, the group of gating functions comprises gating functions corresponding to common pipe diameters, for example 50 mm, 100 mm, 300 mm, 600 mm, and so on.

The signal processor is configured to receive the gating selection signal from an operator input. The operator input can comprise a physical input device such as a button, dial or switch. In such cases, suitably the scanning system will comprise the button, dial or switch. The operator input can comprise an input port of the scanning system configured to receive a software input relating to an operator selection. The operator input can comprise the communications port. The software input can be provided by a computing system coupled to the scanning system.

Suitably, a user can select a pipe diameter, and the system can select an appropriate gating function for that pipe diameter based on the user selection. For example the system can select a gating function corresponding to the selected pipe diameter, or a gating function that most closely corresponds to the selected pipe diameter from a group of gating functions that is available to the scanning system.

The scanning system can be configured to identify the penetration echo peak at a plurality of positions, e.g. relative to a plurality of transducers in the array. Based on the depth or time-of-flight from different transducer elements to the identified penetration echo peak, a curvature of an object under analysis can be determined. A closest matching gating function can be selected that most closely corresponds to the determined curvature. Thus, pipe curvature can be estimated based on the ultrasound reflections, and a gating function corresponding to that pipe curvature can automatically be selected to gate signals reflected from that pipe.

Suitably, the scanning system is configured to analyse a first set of received ultrasound signals to identify a feature in the first set of received ultrasound signals; generate the gating selection signal based on the identified feature to select a gating function; and process a second set of received ultrasound signals using the selected gating function. Identifying the feature can comprise assessing the first set of ultrasound signals against a set of characteristics. Identifying the feature can comprise identifying one or more peaks in the received ultrasound signals having an amplitude that is one or both of greater than a minimum amplitude or respective minimum amplitudes, and less than a maximum amplitude or respective maximum amplitudes.

Identifying the feature can comprise identifying a first peak that exceeds a penetration echo threshold amplitude as a penetration echo, and generating the gating selection signal can comprise selecting a gating function arranged to selectively retain ultrasound signals received after the penetration echo. Data received before the identified penetration echo may be discarded. Identifying the feature can comprise identifying a minimum amplitude in the received ultrasound signals after the penetration echo, and generating the gating selection signal can comprise selecting a gating function arranged to retain ultrasound signals received after the identified minimum amplitude. Ultrasound signals received before the identified minimum amplitude may be discarded.

The scanning system is suitably configured to retain a portion of the received signals with a given time-of-flight after the penetration echo (i.e. a given depth below the surface of the object being scanned). For example, where the region of interest is the top 15 mm of the object, the retained portion can comprise received signals representing a depth of 15 mm following the penetration echo. Identifying the feature can comprise identifying a final peak that exceeds a back wall threshold amplitude as a back wall echo, and generating the gating selection signal can comprise selecting a gating function arranged to selectively retain ultrasound signals based on the timing of the back wall echo. Identifying the feature can comprise identifying a further minimum amplitude after the identified back wall echo and generating the gating selection signal comprises selecting a gating function arranged to retain ultrasound signals received before the identified further minimum amplitude.

Suitably, the signal processor is configured to output the processed signals. The signal processor may be configured to output the processed signals to a storage unit such as a local and/or remote memory. The processed signals can be output to an analysis module for analysing the interior of the object. The processed signals can be output to an image generator for generating an image of the interior of the object. The generated image is suitably output for display on a display. In this way, the interior of the object can be visualised and more easily appreciated by an operator.

A method of imaging structural features below the surface of an object suitably comprises transmitting, from a plurality of transducer elements in an array, ultrasound signals towards an object. The method further comprises receiving, at the plurality of transducer elements, ultrasound signals reflected from the object, enabling data pertaining to an internal structure of the object to be obtained. The received ultrasound signals are processed for imaging an interior of the object, the processing comprising gating the received ultrasound signals based on a position in the array of the transducer element at which the received ultrasound signals are received.

### Pulse Repetition Rate

It is desirable to be able to image the subsurface structure of an object in real time. To achieve this, ultrasound pulses can be transmitted towards the object with a relatively high pulse repetition rate. An example will now be given for a typical scanning speed and pulse repetition frequency. When inspecting a relatively thin object (say, 4-8 mm) of carbon-fibre-reinforced polymer (CFRP) it is possible to configure a scanning system to obtain 20 images or frames per second. In one implementation, two signals can be averaged in the process of generating each image or frame. In one scanning system, signals are received on 16 parallel channels. Thus, in this case, for a 128×128 array of transducer elements, there are (128×128×2×20/16)=40960 pulses per second. Hence the pulse repetition frequency can be seen to be approximately 40 kHz. That is, a pulse or a pulse sequence can be transmitted 40960 times per second towards an object. The pulse sequence can comprise complex pulses. Pulse repetition rates can be higher or lower than 40 kHz. Gathering data, through analysis of the received ultrasound signals, enables the structure of the object to be imaged.

If a frame rate of greater than 20 frames per second is desired, and/or if more than 2 signals are averaged for each frame, then the pulse repetition frequency will increase. Once an ultrasound pulse has been transmitted towards an object, energy of the pulse will penetrate the object. Reflections will be transmitted back towards the transducer. Not all of the energy of the ultrasound signals will be transmitted back to the transducer. Some of the energy will remain in the object, as the ultrasound signals are reflected internally. These internal reflections mean that the energy of the ultrasound signals in the object takes a finite time to die out, or to reduce below a threshold detection energy level, which might be a noise floor.

The time taken for an echo to die out in an object will depend on many factors. These factors may include the characteristics of the transmitted ultrasound signals, such as one or more of frequency. duration and energy. These factors may include the characteristics of the object to be imaged, such as one or more of the material of the object, its structure and its thickness. These factors may include the characteristics of the scanning system used to image an object, such as a characteristic of the transducer module (e.g. one or more of transducer resolution, transducer frequency, transducer frequency range, transducer size, the number of transducer elements, and so on) and the coupling between the transducer module and the object (e.g. material and/or thickness and/or shape of a dry coupling, material and/or thickness and/or shape of a coupling shoe, material and/or depth of a coupling fluid). The time taken for an echo to die out is frequency dependent. This is because attenuation is usually lower for lower frequencies.

As an example, an ultrasound echo in a material made of or comprising metal will take longer to die out than a similar ultrasound echo in a composite material.

Where the pulse repetition rate is high enough, a subsequent pulse will be transmitted towards the object before the echoes from the previous pulse have reduced to background levels. This means that reflections caused by the previous pulse will be received at the transducer together with reflections caused by the current pulse. The combination of these reflections can cause artefacts in the resulting ultrasound image. Such artefacts can reduce the quality of the ultrasound images, for example by introducing spurious effects or by masking features.

These artefacts can also be caused by echoes within a delay line located along the ultrasound transmission direction from the transmitting surface of the ultrasound transducer. The delay line can comprise a coupling pad such as a dry coupling. The delay line can comprise a coupling shoe, such as a coupling shoe comprising a reservoir for holding coupling fluid.

These artefacts can be reduced or avoided by manually controlling a time delay between transmission of each pulse or pulse sequence in the ultrasound signals. In the above example, ultrasound signals may be transmitted with a time delay t between sets of signals (where a set of transmitted ultrasound signals comprises a pulse or a pulse sequence of finite duration). In an example where the pulse or pulse sequence is 3 μs in duration, for a pulse repetition frequency of 40960 Hz and a frame rate of 20 frames per second, a time delay t of up to approximately 20 μs can be provided. Complex pulses or pulse sequences may be longer in duration than 3 μs, meaning that the time delay possible, whilst maintaining pulse repetition frequency and frame rate, will decrease.

To reduce the artefacts caused by long-lasting echoes in the object, the time delay can be increased to, for example, 30 μs or 40 μs. In the absence of other changes, this can lead to a reduction in pulse repetition frequency from ˜40 kHz to ˜30 kHz or ˜20 kHz. Increases in the time delay between pulses or sequences of pulses can impact the frame rates achievable. Increases in the time delay will mean that it will take longer to obtain an equivalent amount of data obtainable with lower time delays, and so frame rates may decrease. Frame rates can be maintained by sacrificing the amount of data captured for each frame, for example by averaging fewer results per frame.

Thus, there is a trade-off between higher frame rates (enabling faster scans and/or more accurate scans of dynamic processes) and higher signal to noise ratios (increasing the accuracy of the data obtained). Adjusting pulse repetition frequency can help ensure that there are no “old” echoes (or reflections from a previous measurement) in the data of interest, whilst trying to achieve as high a frame rate as possible.

It can be arduous and time consuming to manually reconfigure a scanning system before each scan to find a balance between frame rate and signal to noise ratio. It is also arduous to update the configuration during a scan—this would necessitate interrupting the standard data capture to vary the time delay manually and assess the results by viewing the resulting images obtained using the scanning system.

In a manual system, if a scanning apparatus is moved so that it changes from scanning one area to scanning another area with a differing material or structure, the time delay, or pulse repetition rate, will no longer be optimal. This could lead, in one situation (e.g. moving to an area where echoes take longer to die out) to artefacts being introduced, and in another situation (e.g. moving to an area where echoes die out more quickly) to a frame rate that is lower than necessary.

It is therefore desirable to provide an automatic way of identifying an optimal, or a desired, time delay. It is also desirable to ensure that the time delay is updated or optimised dynamically during a scanning process. An optimal time delay can be found where the pulse repetition rate is as high as possible to satisfy a signal to noise condition such as a threshold signal to noise ratio. An optimal time delay can be found where the pulse repetition rate is as high as possible to satisfy an artefact condition such as a threshold amplitude of the artefact, e.g. a threshold amplitude of a peak associated with the artefact. In general, the artefact can be considered to be, or to form at least part of, a feature in ultrasound signals received from the object.

Further detail of a scanning system in accordance with techniques relating to pulse repetition rate is described below with reference to the figures.

A scanning system is for imaging structural features below the surface of an object. The scanning system comprises a transducer module and an analysis module. The transducer module is configured to transmit ultrasound signals towards an object and to receive ultrasound signals reflected from the object whereby data pertaining to an internal structure of the object can be obtained. The analysis module is coupled to the transducer module and is configured to analyse received ultrasound signals to identify a feature in the received ultrasound signals. The transducer module is configured to transmit further ultrasound signals at a time delay t after the ultrasound signals, where the time delay t is determined in dependence on the identified feature.

Suitably the analysis module is configured to identify an amplitude of a peak in the received ultrasound signals, and the identified feature comprises a change in the amplitude of the peak. Suitably the peak in the received ultrasound signals is a peak of a reflection received from within the object.

As discussed elsewhere herein, the scanning system is configured to identify, in the received ultrasound signals, the penetration echo and the back wall echo. The penetration echo may be used to determine the feature in the received ultrasound signals. The amplitude of the penetration echo can provide information about the amount of energy that couples into the object. Where the penetration echo is relatively low, it can be determined that a relatively greater amount of the energy in the transmitted ultrasound signals couples into the object, and where the penetration echo is relatively high, it can be determined that a relatively lower amount of the energy in the transmitted ultrasound signals couples into the object. Where a relatively greater amount of energy couples into the object, the internal reflections in the object are likely to take relatively longer to die out (e.g. by falling below a threshold detection limit such as a noise floor).

The analysis module need not use the penetration echo. The analysis module can determine a peak in the received ultrasound signals subsequent to the penetration echo, and use this subsequent peak to determine the feature in the received ultrasound signals. The subsequent peak may be a back wall echo (which can, for example, be identified as described elsewhere herein). The analysis module may, in some implementations, be configured to determine the feature in dependence on a plurality of peaks. Suitably the plurality of peaks comprises peaks following the penetration echo. For example, the plurality of peaks comprises peaks following the penetration echo and preceding the back wall echo. That is, the one or more peaks used by the analysis module to determine the feature in the received ultrasound signals are suitably between the penetration echo and the back wall echo.

Basing the determination of the feature on a plurality of peaks can increase the accuracy of the determination of the feature, for example by increasing the size of the data set from which the feature is determined.

The feature can be based on some combination of the penetration echo, one or more peaks between the penetration echo and the back wall echo, and the back wall echo. Selecting the most appropriate combination can enhance the accuracy of the determination, e.g. by increasing the size of the data set from which the feature is determined. The particular combination used can be selected based on one of, or any combination of the following: the signal to noise ratio of one or more of the peaks, the material of the object, the material of a coupling material between the transducer module and the object, the frequency or frequency range of the transmitted ultrasound signals, and the energy in the transmitted ultrasound signals.

It is possible to use the scanning apparatus to scan a calibration block and to use the results from that scan to determine a time delay to use in subsequent scans performed on an object to be imaged. For instance, a calibration block can be selected that may approximate the object to be scanned, e.g. by being made of the same or a similar material, or a material with a similar response to ultrasound. For example, the calibration block may have an acoustic impedance that approximates the acoustic impedance of an object to be scanned. The precise nature of the object to be scanned may not be known before it is scanned. However, in this case, an expected or predicted characteristic or behaviour may be determined and a suitable calibration block selected based on this expected characteristic or behaviour. For example, a calibration block from a range of different calibration blocks can be selected that has an acoustic impedance closest to an expected acoustic impedance of the object. The calibration block to use can be selected based on one or more factors, including the acoustic impedance, a thickness of the calibration block, a shape of the calibration block, a feature such as a material discontinuity within the calibration block, and so on.

Based on scanning the calibration block, the analysis module can determine a time delay. This time delay can be used when scanning the object. This determined time delay can be used throughout the scan of the object. Alternatively, this determined time delay can be used as a starting time delay, to be used at the start of the scan on the object. This approach can increase the accuracy of the initial scan. The time delay can then be subsequently dynamically modified based on further analysis performed at the analysis module on ultrasound signals received from the object.

In some implementations, data obtained during an ultrasound scan is normalised. Using the techniques discussed herein, it is possible to decrease waiting time after normalisation, during inspection, based on the penetration echo. This is because analysis of the penetration echo enables determination of the amount of energy (e.g. as a percentage of the transmitted pulse) that enters the object.

Suitably, the identified feature comprises a rate of change of the amplitude of the peak. The rate of change of the amplitude can give an indication of how the internal echoes are dying out in the object. The identified feature may comprise a percentage change in the amplitude of the peak compared to an initially determined amplitude of the peak. This approach enables determination of a proportion or percentage by which the amplitude (or the energy) of the echo(es) drops. For example, it is possible to determine when an amplitude (of one peak or of a combination of peaks) drops to below 60% of the initial amplitude (or any other desired or predetermined threshold percentage). This can indicate that the echoes have died away sufficiently for the subsequent pulse to be triggered, without these echoes adversely affecting the analysis of the reflected signals.

The identified feature can comprise a change in the amplitude of the peak past a threshold amplitude, for example where the amplitude falls lower than a predetermined threshold. This approach ensures that the absolute amplitude of echoes within or from the object falls to an acceptable level before triggering the subsequent pulse. The threshold amplitude is suitably based on one or more of a material of an object for scanning; a structure of an object for scanning; a depth of a feature of interest; a flaw to be investigated; a thickness of an object for scanning; a coupling medium to be used between the transducer module and an object for scanning; a characteristic of the transducer module; and a threshold selection value. The threshold selection value can be set by a user before scanning. The threshold selection value can be set by a user during scanning. allowing dynamic selection by the user.

Materials such as steel and aluminum have very low attenuation meaning that sound will travel back and forth many times in a plate of a few mm thickness. When calibrating sound velocity, or thickness, it is possible to calculate and estimate a sensible re-transmit time (i.e. a time delay between transmission of subsequent pulses), based on the thickness of the material. In this manner, the re-transmit time can be considered part of the “calibration” of a known material such as a step-wedge and so on.

The identified feature is suitably indicative of a level of corrosion in the object. E.g. the identified feature can indicate the presence of corrosion, such as rust in the object. The corrosion may be at the front surface of the object, i.e. the surface of the object facing the scanning apparatus. The corrosion may be at the back surface of the object, i.e. the surface of the object facing away from the scanning surface. Suitably the front surface of the object is opposite the back surface of the object. The identified feature is preferably indicative of whether corrosion is present at the front surface and/or at the back surface. The identified feature is suitably indicative of whether the corrosion is on an external face of the object and/or at an interior of the object. The analysis module can be configured to determine the presence of corrosion by looking for characteristic patterns in the received ultrasound signals that typically are associated with corrosion in objects. Similarly, the analysis module can be configured to determine whether corrosion is on or at an external face of the object and/or internal to the object, by comparison of the received ultrasound signals with a known set of ultrasound signals, or characteristics of such a known set of ultrasound signals. For example, a match filter can be used to determine a match, or closest match to a known signal pattern. By one or more of such comparisons, the analysis module can determine one or more features in the received ultrasound signals.

The identified feature can indicate an ultrasound path length between a transmitting surface of the transducer module and the object. For example, the identified feature can be indicative of a thickness of a delay line, such as a coupling pad disposed between the transmitting surface and the object, and/or of a depth of coupling fluid between the transmitting surface and the object. The depth of coupling fluid can be the depth (or thickness) of a coupling shoe used to retain coupling fluid. The depth of coupling fluid can, for example, be the depth of a coupling fluid reservoir of a coupling shoe. The depth of coupling fluid can be the distance travelled by ultrasound waves in a transmission direction of the ultrasound waves between the transmitting surface and the surface of the object. Knowledge of the ultrasound path length can be useful in determining how ultrasound echoes may die out over time. For example, a relatively longer path length typically means that absorption will be greater than for a relatively shorter path length. Thus, the echoes are more likely to die away more quickly. Knowledge of path lengths through different materials can be useful in determining how ultrasound signals may die out over time. For example, a greater number of materials in the path is likely to result in more reflections at acoustic boundaries, which can increase the rate at which echoes die out.

The identified feature is suitably indicative of a noise level in the received ultrasound signals. For example, the noise level can comprise the level of a noise floor in the received ultrasound signals, or an average noise level over time. Detecting whether there are pulses that exceed the noise floor (e.g. where pulse amplitude exceeds a level of the noise floor) can lead to identifying the presence of a pulse in an unexpected location. This unexpected pulse can give rise to an artefact in an ultrasound image. It is possible to use the present techniques, for example during a normalisation or calibration step, to identify such unexpected pulses Once these unexpected pulses have been identified, the time delay can be adjusted accordingly. The adjustment of the time delay, for example by increasing the time delay, suitably is so as to reduce the amplitude of these pulses and to diminish the corresponding artefact.

As described elsewhere herein, the transducer module can comprise a plurality of transducer elements arranged in an array. In such a transducer module, suitably the time delay t is the same for each transducer element. The time delay t can comprise a first time delay t₁ for a first subset of the transducer elements and a second time delay t₂ for a second subset of the transducer elements. The first time delay t₁ is determined in dependence on ultrasound signals received at the first subset of the transducer elements and the second time delay t₂ is determined in dependence on ultrasound signals received at the second subset of the transducer elements. For each transducer element, the analysis module is configured to analyse ultrasound signals received at that transducer element to identify a respective feature in the received ultrasound signals, and a respective time delay tresp is determined in dependence on the respective identified feature for that transducer element. Suitably, the respective time delays tᵣₑₛₚ for each transducer element in the array fit a function that varies smoothly with position in the array.

This approach permits the time delay to be separately determined for different transducers within the array of transducers that form the transducer module. The time delay can be separately determined for groups of transducers in the array, and even for each separate transducer in the array. This permits time delays to be provided that are appropriate for the position in the array of each group of transducers or of each transducer. This approach can be useful where the material characteristics and/or coupling differs across an object. A step-wedge can be used in between the transducer module and the object. Coupling fluid can be provided that may have a different thickness at various portions of the interface. These, and other, factors can affect the coupling between the transducer module and the object. Analysing the ultrasound signals received at each group of transducers, or at each transducer, enables these coupling effects to be taken into account when determining the appropriate time delay for each transducer in the transducer module. Thus, the scanning system can obtain more accurate data for subsequent analysis. For example, it may be more appropriate to shorten the time delay for a transducer element adjacent a thick part of a step-wedge since, by the time the ultrasound has passed into the material, the echoes will have died out more, and so a shorter time delay can be appropriate. Conversely, it can be more appropriate to lengthen the time delay for a transducer element adjacent a thin part of the step-wedge since the echoes in the object will have less time to die out before the ultrasound signals are coupled into that part of the object.

It is not necessary for the time delay to be different at each group or transducer elements or at each transducer element, even if the calculated time delays are different. In some implementations, the longest time delay calculated is applied to each transducer element.

As mentioned elsewhere herein, a scanning system 900 can comprise an image generator 912 configured to generate an image scan representative of structural features below a surface of an object in dependence on the received ultrasound signals; a display 914 coupled to the image generator and configured to display the image scan 1306; and a user input device configured to generate an indication signal 1308 whereby a user can indicate a portion of the displayed image scan. The analysis module is configured to identify the feature in response to the generated indication signal 1310. In this way, a user can select a location in the image on which to base the timing of subsequent signals. A user can indicate an artefact in the image, so that the adjustment of the timing of the pulse re-triggering takes the indicated artefact into account. The user can select more than one location in the image. Where multiple locations are selected in the image, the analysis module can perform an analysis at each location separately, or combine the analysis for multiple locations, for example by averaging amplitudes and so on from each location.

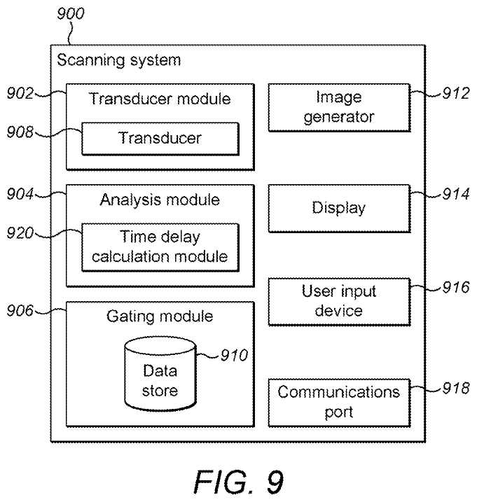

With reference to FIG. 9, it is noted that the gating module 906 need not be provided as part of the scanning system in all implementations. The analysis module may comprise a match filter module (not shown) and/or a time delay calculation module 920. Suitably the scanning system comprises one or more processors configured by hardware and/or software to carry out the analysis described herein. For example, at least one of the one or more processors can be provided in or as part of the analysis module 904.

A further method will now be described with reference to FIG. 15. Ultrasound signals are transmitted by a transducer module, for example by one or more transducer elements forming at least part of the transducer module. Reflections of the transmitted ultrasound signals are received 1502. The received ultrasound signals are analysed 1504. The analysis permits one or more features in the received ultrasound signals to be identified 1506. The one or more features can be identified by feature matching algorithms or similar. For example, a match filter can be used to identify matches with an expected shape of a reflected signal. At 1510, further ultrasound signals are transmitted at a time delay t after the ultrasound signals. The time delay t is determined in dependence on the one or more identified features.

Any one or more of the techniques described herein in relation to pulse repetition rate can be combined with any one or more of the techniques described herein in relation to gating ultrasound signals, as appropriate.

The apparatus and methods described herein are particularly suitable for detecting debonding and delamination in composite materials such as carbon-fibre-reinforced polymer (CFRP). This is important for aircraft maintenance. It can also be used to detect flaking around rivet holes, which can act as a stress concentrator. The apparatus is particularly useful for detecting corrosion, welding, cracks, and so on, in metals or metallic structures. The apparatus is particularly suitable for applications where it is desired to image a small area of a much larger component. The apparatus is lightweight, portable and easy to use. It can readily be carried by hand by an operator to be placed where required on the object.

The structures shown in the figures herein are intended to correspond to a number of functional blocks in an apparatus. This is for illustrative purposes only. The functional blocks illustrated in the figures represent the different functions that the apparatus is configured to perform; they are not intended to define a strict division between physical components in the apparatus. The performance of some functions may be split across a number of different physical components. One particular component may perform a number of different functions. The figures are not intended to define a strict division between different parts of hardware on a chip or between different programs, procedures or functions in software. The functions may be performed in hardware or software or a combination of the two. Any such software is preferably stored on a non-transient computer readable medium, such as a memory (RAM, cache, FLASH, ROM, hard disk etc.) or other storage means (USB stick, FLASH, ROM, CD, disk etc). The apparatus may comprise only one physical device or it may comprise a number of separate devices. For example, some of the signal processing and image generation may be performed in a portable, hand-held device and some may be performed in a separate device such as a PC, PDA or tablet. In some examples, the entirety of the image generation may be performed in a separate device. Any of the functional units described herein might be implemented as part of the cloud.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A scanning system for imaging structural features below the surface of an object, the scanning system comprising:
a transducer module configured to transmit ultrasound signals towards an object and to receive ultrasound signals reflected from the object whereby data pertaining to an internal structure of the object can be obtained; and
an analysis module coupled to the transducer module and configured to analyse received ultrasound signals to identify a feature in the received ultrasound signals;
in which the transducer module is configured to transmit further ultrasound signals at a time delay t after the ultrasound signals, where the time delay t is determined in dependence on the identified feature.

2. A scanning system according to claim 1, in which the analysis module is configured to identify an amplitude of a peak in the received ultrasound signals, and the identified feature comprises a change in the amplitude of the peak.

3. A scanning system according to claim 2, in which the peak in the received ultrasound signals is a peak of a reflection received from within the object.

4. A scanning system according to claim 2, in which the identified feature comprises a rate of change of the amplitude of the peak.

5. A scanning system according to claim 2, in which the identified feature comprises a percentage change in the amplitude of the peak compared to an initially determined amplitude of the peak.

6. A scanning system according to claim 2, in which the identified feature comprises a change in the amplitude of the peak past a threshold amplitude.

7. A scanning system according to claim 6, in which the threshold amplitude is based on one or more of:
a material of an object for scanning;
a structure of an object for scanning;
a depth of a feature of interest;
a flaw to be investigated;
a thickness of an object for scanning;
a coupling medium to be used between the transducer module and an object for scanning;
a characteristic of the transducer module; and
a threshold selection value.

8. A scanning system according to claim 1, in which the identified feature is indicative of a level of corrosion in the object.

9. A scanning system according to claim 8, in which the identified feature is indicative of whether the corrosion is on an external face of the object and/or at an interior of the object.

10. A scanning system according to claim 1, in which the identified feature is indicative of an ultrasound path length between a transmitting surface of the transducer module and the object.

11. A scanning system according to claim 1, in which the identified feature is indicative of a thickness of a coupling pad disposed between the transmitting surface and the object.

12. A scanning system according to claim 1, in which the identified feature is indicative of a depth of coupling fluid between the transmitting surface and the object.

13. A scanning system according to claim 1, in which the identified feature is indicative of a noise level in the received ultrasound signals.

14. A scanning system according to claim 1, in which the transducer module comprises a plurality of transducer elements arranged in an array, and the time delay t is the same for each transducer element.

15. A scanning system according to claim 1, in which the transducer module comprises a plurality of transducer elements arranged in an array, and the time delay t comprises a first time delay t₁ for a first subset of the transducer elements and a second time delay t₂ for a second subset of the transducer elements.

16. A scanning system according to claim 15, in which the first time delay t₁ is determined in dependence on ultrasound signals received at the first subset of the transducer elements and the second time delay t₂ is determined in dependence on ultrasound signals received at the second subset of the transducer elements.

17. A scanning system according to claim 16, in which, for each transducer element:
the analysis module is configured to analyse ultrasound signals received at that transducer element to identify a respective feature in the received ultrasound signals, and
a respective time delay tᵣₑₛₚ is determined in dependence on the respective identified feature for that transducer element.

18. A scanning system according to claim 17, in which the respective time delays tᵣₑₛₚ for each transducer element in the array fit a function that varies smoothly with position in the array.

19. A scanning system according to claim 1, in which the scanning system comprises an image generator configured to generate an image scan representative of structural features below a surface of an object in dependence on the received ultrasound signals; a display coupled to the image generator and configured to display the image scan; and a user input device configured to generate an indication signal whereby a user can indicate a portion of the displayed image scan; the analysis module being configured to identify the feature in response to the generated indication signal.

20. A method of imaging structural features below the surface of an object, the method comprising:
transmitting ultrasound signals towards an object and to receive ultrasound signals reflected from the object whereby data pertaining to an internal structure of the object can be obtained; and
analysing received ultrasound signals to identify a feature in the received ultrasound signals; and
transmitting further ultrasound signals at a time delay t after the ultrasound signals, where the time delay t is determined in dependence on the identified feature.
